(19) United States
(12) Patent Application Publication
(10) Pub. No.: US 2023/0311731 A1
(43) Pub. Date: Oct. 5, 2023

(54) ENGINEERED BUS FOAM SOLUTION FOR SCHOOL BUS SEAT

(71) Applicant: Indiana Mills & Manufacturing, Inc., Westfield, IN (US)

(72) Inventors: Darshan Racca, Carmel, IN (US); Jonathan Austin DuBois, Cicero, IN (US)

(73) Assignee: Indiana Mills & Manufacturing, Inc., Westfield, IN (US)

(21) Appl. No.: 18/192,303

(22) Filed: Mar. 29, 2023

Related U.S. Application Data
(60) Provisional application No. 63/362,097, filed on Mar. 29, 2022.

(51) Int. Cl. B60N 2/68; B60N 2/24; B60N 2/42

(52) U.S. Cl. CPC B60N 2/686; B60N 2/242; B60N 2/42

(57) ABSTRACT

A bus seat including a seat back and a seat bottom. The seat back further includes a panel and a housing. The housing is a modular and configured to receive a variety of different panels. In one example, attachment of the panel to the housing defines a cavity. In another example, the cavity is filled with an energy absorbing material. In another example, the energy absorbing material is expanded polystyrene (EPS) foam and/or expanded polypropylene (EPP) foam. The seat back further includes a pair of parallel mounting posts disposed between the panel and the housing. The mounting posts include a plurality of fastener mounting locations to enable a universal fit. In another embodiment, the seat back includes one or more energy absorbing portions configured to absorb energy in the event of an accident.

### CROSS REFERENCE TO RELATED APPLICATIONS

This application claims the benefit of U.S. Patent Application No. 63/362,097, filed Mar. 29, 2022, which is hereby incorporated by reference.

### BACKGROUND

Currently, outfitting bus seats with safety features, such as buckle assemblies and/or built-in child safety seats requires altering the manufacturing process, which lowers efficiency and increases cost. Additionally, if a bus requires some seats to include some safety features and other seats to include other safety features, the overall time and cost to assemble and manufacture the bus is also increased. The lack of a standardized bus seat manufacturing process can also lead to error in manufacturing, which may lead to dangerous circumstances for a passenger.

Thus, there is a need for improvement in this field.

### SUMMARY

A unique modular bus seat system has been developed to create a uniform manufacturing process for bus seats. The bus seat system includes a seat back with a panel and a housing. In one example, the housing is modular and able to receive a variety of different panels without modification. As should be appreciated, having a housing configured to accept a variety of different panels allows for a more uniform and less costly manufacturing process.

The panel generally mounts to the housing via an adhesive. In another example, the panel mounts to the housing via one or more fasteners. In yet another example, the panel mounts to the housing via a series of interlocking members. In some exemplar housings, the housing further includes an overhanging shroud configured to provide additional protections to passengers in the event of an accident. In one example, the housing and the shroud are manufactured from a single piece of material. In another example, the housing and the shroud are a single molded component. The interior portion of the bus seat is disposed between the panel and the housing. The interior portion generally includes a pair of parallel mounting posts configured to secure the bus seat. In another example, the mounting posts serve as a crumple zone in the event of an accident. The mounting posts include a plurality of fastener mounting locations configured to mate with one or more mounting legs and/or a frame of the bus seat. As should be appreciated, the mounting posts are designed as a universal fit to accommodate common bus seat mounting arrangements. In one embodiment, the interior portion of the bus seat is filled with a force absorbing material. In one example, the force absorbing material includes foam. In another example, the force absorbing material includes expanded polystyrene (EPS) foam and/or expanded polypropylene (EPP) foam. In yet another embodiment, the foam is injected into the interior portion of the bus seat after assembly.

The bus seat further includes one or more energy absorbing portions. In one embodiment, the bus seat includes energy absorbing portions configured to protect the knees and/or head of a passenger. As should be appreciated, the energy absorbing portions are configured to minimize the amount of impact force felt by a passenger during an accident and/or other event. In one example, the energy absorbing portions extend transverse to the cushion of the seat bottom. In another example, the energy absorbing portions are made from foam. In yet another example, the energy absorbing portions are made from EPS and/or EPP. As should be appreciated, the bus seat is designed to meet the requirements of FMVSS 222.

As mentioned previously, the housing is modular and able to accept a variety of different panel designs. For example, the panel may include one or more buckle assemblies, one or more built-in child safety seats, and/or a combination of buckle assemblies and child safety seats. In another example, the panel may include no buckle assemblies and/or child safety seats. However, due to the modular configuration of the housing, little to no manufacturing changes are needed to mount different panels. Thus, manufacturing time and costs are reduced.

The system and techniques as described and illustrated herein concern a number of unique and inventive aspects. Some, but by no means all, of these unique aspects are summarized below.
Aspect 1 generally concerns a system.
Aspect 2 generally concerns the system of any previous aspect including a bus seat.
Aspect 3 generally concerns the system of any previous aspect including a seat back.
Aspect 4 generally concerns the system of any previous aspect in which the seat back includes a housing.
Aspect 5 generally concerns the system of any previous aspect in which the housing includes one or more buckle mounting locations.
Aspect 6 generally concerns the system of any previous aspect in which the housing is in a form of a knee block.
Aspect 7 generally concerns the system of any previous aspect in which the knee block is a molded foam component.
Aspect 8 generally concerns the system of any previous aspect in which the housing has a scalable design.
Aspect 9 generally concerns the system of any previous aspect in which the panel and the housing interlock with one another.
Aspect 10 generally concerns the system of any previous aspect in which the housing has a lip molded into the housing.
Aspect 11 generally concerns the system of any previous aspect in which the housing is a unitary molded component configured to accept multiple different panel designs.
Aspect 12 generally concerns the system of any previous aspect in which the seat back includes a panel.
Aspect 13 generally concerns the system of any previous aspect in which the panel includes one or more buckle openings configured to align with the buckle mounting locations of the housing.
Aspect 13 generally concerns the system of any previous aspect in which the foam is expanded polystyrene (EPS) foam.
Aspect 14 generally concerns the system of any previous aspect in which the panel includes one or more child safety seat openings configured to align with the one or more child safety seats secured within the cavity of the housing.
Aspect 15 generally concerns the system of any previous aspect in which the seat back includes a panel secured to a modular housing.
Aspect 16 generally concerns the system of any previous aspect in which the panel is a front panel and housing is a rear panel.
Aspect 17 generally concerns the system of any previous aspect in which the seat back includes a cavity between the front panel and the rear panel.
Aspect 18 generally concerns the system of any previous aspect in which the cavity is configured to receive a foam insert.
Aspect 19 generally concerns the system of any previous aspect in which the foam is expanded polypropylene (EPP) foam and/or in which the foam insert is supplied via injection molding.
Aspect 20 generally concerns the system of any previous aspect in which the cavity houses a knee insert to alleviate knee impacts.
Aspect 21 generally concerns the system of any previous aspect in which the cavity houses a head insert to alleviate head impacts.
Aspect 22 generally concerns the system of any previous aspect in which the front panel is secured to the rear panel via adhesive.
Aspect 23 generally concerns the system of any previous aspect in which the housing is molded.
Aspect 24 generally concerns the system of any previous aspect in which the seat back includes a pair of parallel mounting posts within the interior portion.
Aspect 25 generally concerns the system of any previous aspect in which the mounting posts are configured as a universal fit for one or more mounting legs.
Aspect 26 generally concerns the system of any previous aspect in which the mounting posts include a plurality of fastener mounting locations.
Aspect 27 generally concerns the system of any previous aspect in which the seat back includes an energy absorbing portion configured to increase energy absorption.
Aspect 28 generally concerns the system of any previous aspect in which the seat back includes the panel and the housing.
Aspect 29 generally concerns the system of any previous aspect in which the panel is secured to the housing.
Aspect 30 generally concerns the system of any previous aspect in which the panel and the housing define a cavity.
Aspect 31 generally concerns the system of any previous aspect in which the panel defines one or more openings.
Aspect 32 generally concerns the system of any previous aspect in which the openings is configured to provide access to a buckle assembly.
Aspect 33 generally concerns the system of any previous aspect in which the openings are configured to provide access to a child safety seat.
Aspect 34 generally concerns the system of any previous aspect in which the openings are shaped to receive a child safety seat.
Aspect 35 generally concerns the system of any previous aspect in which the panel is made of a flat, continuous piece of material.
Aspect 36 generally concerns the system of any previous aspect in which the panel and the housing are made of foam.
Aspect 37 generally concerns the system of any previous aspect in which the foam includes expanded polystyrene and/or expanded polypropylene.
Aspect 38 generally concerns the system of any previous aspect in which the housing includes one or more energy absorbing portions configured to absorb energy in the event of an accident.
Aspect 39 generally concerns the system of any previous aspect in which the seat back includes the housing and the panel secured to the housing.
Aspect 40 generally concerns the system of any previous aspect in which the panel is adhered around an outer periphery of the panel to the housing via an adhesive.
Aspect 41 generally concerns the system of any previous aspect in which the frame coupled to the seat back.
Aspect 42 generally concerns the system of any previous aspect in which the seat back and frame are arranged to have a geometry to promote energy absorption.
Aspect 43 generally concerns the system of any previous aspect including a seat bottom.
Aspect 44 generally concerns the system of any previous aspect in which the seat back is attached to the seat bottom.
Aspect 45 generally concerns a method.
Aspect 46 generally concerns the method of any previous aspect including molding a housing to form a back panel of a bus seat back.
Aspect 47 generally concerns the method of any previous aspect including securing a front panel to the housing to create a cavity in the bus seat back.
Aspect 48 generally concerns the method of any previous aspect including forming one or more openings in the front panel.
Aspect 49 generally concerns the method of any previous aspect including attaching a mounting post into the housing.
Aspect 50 generally concerns the method of any previous aspect including inserting a frame into the housing by attaching the frame to the mounting post.
Aspect 51 generally concerns the method of any previous aspect including adhering an outer periphery of the front panel to the housing using adhesives.
Aspect 52 generally concerns the method of any previous aspect including attaching one or more buckle assemblies to the housing through the openings.
Aspect 53 generally concerns the method of any previous aspect including securing one or more child safety seats in the cavity of the housing.
Aspect 54 generally concerns the method of any previous aspect including inserting a foam insert into the cavity of the housing.
Aspect 55 generally concerns the method of any previous aspect including modifying impact force values by changing hole density in the foam insert.
Aspect 56 generally concerns the method of any previous aspect including attaching one or more energy absorbing portions to the housing.
Aspect 57 generally concerns the method of any previous aspect in which the housing is a first housing.
Aspect 58 generally concerns the method of any previous aspect including molding a second housing configured in a same fashion as the first housing.
Aspect 59 generally concerns the method of any previous aspect in which the front panel is a first front panel.
Aspect 60 generally concerns the method of any previous aspect including securing a second front panel to the second housing.
Aspect 61 generally concerns the method of any previous aspect in which the second front panel is constructed differently than the first front panel.
Aspect 62 generally concerns the method of any previous aspect in which the first front panel and the second front panel have different opening patterns.
Aspect 63 generally concerns the method of any previous aspect in which the front panel and the back panel of the housing are made of foam.
Aspect 64 generally concerns a method of operating the system of any previous aspect.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a seat assembly.

FIG. 2 is a perspective view of a seat back that can be incorporated into the seat assembly of FIG. 1.

FIG. 3 is a cross-sectional view of the front of the seat back illustrated in FIG. 2.

FIG. 4 is a cross-sectional view of the side of the seat back illustrated in FIG. 2.

FIG. 5 is an exploded view of the seat back illustrated in FIG. 2.

FIG. 6 is a front perspective view of a seat back that can be incorporated into the seat assembly of FIG. 1.

FIG. 7 is a side view of the seat back illustrated in FIG. 2.

FIG. 8 is a rear view of the seat back illustrated in FIG. 2.

FIG. 9 is a top view of the seat back illustrated in FIG. 2.

FIG. 10 is a bottom view of the seat back illustrated in FIG. 2.

FIG. 11 is an exploded view of a seat back that can be incorporated into the seat assembly of FIG. 1.

FIG. 12 is a top perspective view of a seat back that can be incorporated into the seat assembly of FIG. 1.

FIG. 13 is a perspective view of a seat back that can be incorporated into the seat assembly of FIG. 1.

FIG. 14 is a perspective view of another example of a seat back that can be incorporated into the seat assembly of FIG. 1.

FIG. 15 is a perspective view of another example of a seat back that can be incorporated into the seat assembly of FIG. 1.

FIG. 16 is a perspective view of another example of a seat back that can be incorporated into the seat assembly of FIG. 1.

FIG. 17 is a perspective view of another example of a seat back that can be incorporated into the seat assembly of FIG. 1.

FIG. 18 is a perspective view of an example of a panel that can be incorporated into the seat assembly of FIG. 1.

FIG. 19 is a front view of the seat back illustrated in FIG. 2 with buckle assemblies and a child safety seat incorporated into the seat back.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

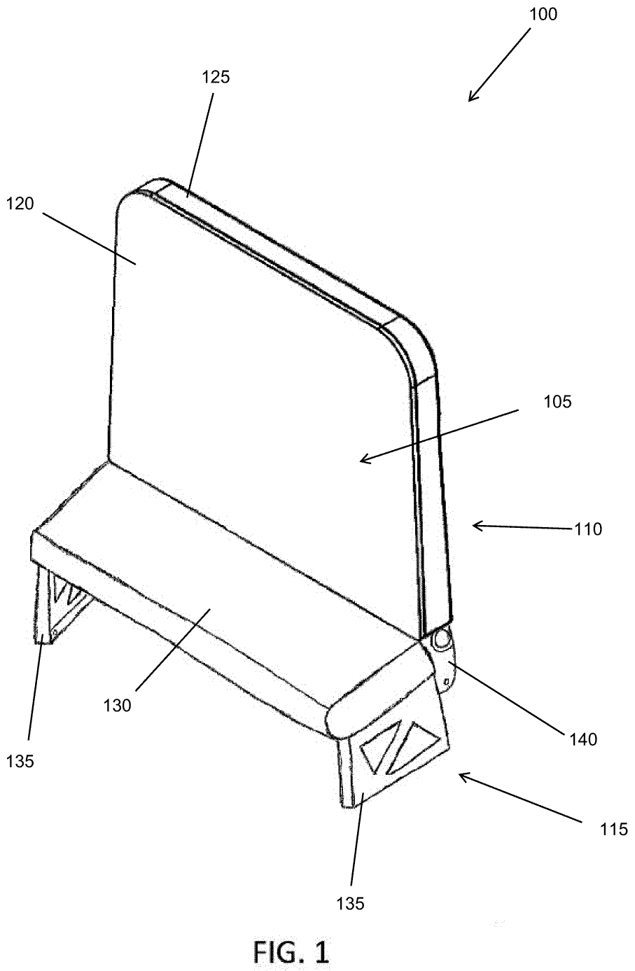

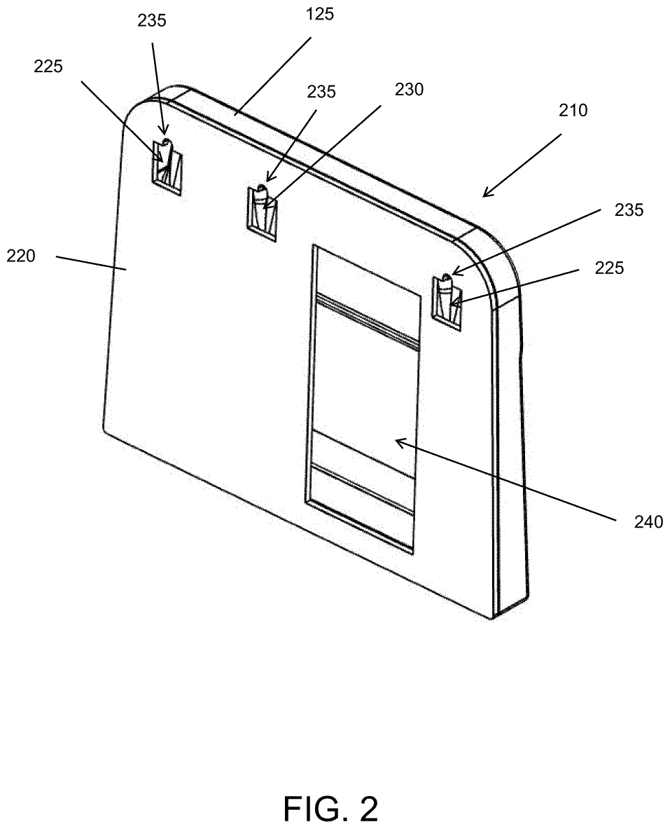

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIG. 1 illustrates an example of a seat assembly 100. The seat assembly 100 includes a seat 105. The seat 105 is generally defined by a seat back 110 and a seat bottom 115. Specifically, the seat bottom 115 extends generally transverse to the seat back 110. As such, the seat 105 is configured for use by one or more passengers of a vehicle, such as, for example, a school bus. The seat back 110 generally includes a panel 120 and a housing 125. The panel 120 is attached to the housing 125. In one example, the panel 120 is attached to the housing 125 via adhesives. As shown in FIG. 1, the panel 120 generally flat, planar shape. In one example, the panel 120 is made of foam. In other examples, the panel 120 is made of expanded polystyrene (EPS) and/or expanded polypropylene (EPP).

The seat bottom 115 generally includes a cushion 130 and mounting pedestals 135. In one example, the cushion 130 is made of foam. However, in other examples, EPS and/or EPP are used to manufacture the cushion 130. In this embodiment, the cushion 130 is illustrated with a generally flat shape. In other examples, the cushion 130 may slope towards the seat back 110 to angle passengers into a proper seating position, also known as a submarining configuration. The mounting pedestals 135 are attached to the cushion 130, for example, via fasteners. In other examples, the mounting pedestals 135 are attached to the seat back 110 and the seat bottom 115. The mounting pedestals 135 are configured to support the seat assembly 100 and further to attach the seat assembly 100 to a vehicle. In this embodiment, the seat assembly 100 further includes a support rod 140. The support rod 140 is configured to selectively position the seat 105 at different angles. Said differently, the support rod 140 allows the near ninety-degree angle between the seat back 110 and the seat bottom 115 to be adjusted by passengers and/or an operator of the vehicle. In other embodiments, the angle between the seat back 110 and the seat bottom 115 is static and cannot be adjusted.

The housing 125 is a unique, modular design such that the housing 125 is configured to receive various configurations of panels 120 (see FIGS. 2, 14, 15, 16, 17, and 18). FIG. 1 illustrates the panel 120 as a solid, continuous piece. However, as discussed below, other configurations of the panel 120 are possible without the need for variation in the manufacturing process of the seat assembly 100 and/or the seat back 110. This modular design allows for the housing 125 to be used regardless of the intended use of the seat assembly 100 and the seat 105. For example, the intended use of the seat 105 in one instance is to support two adult passengers. In another example, the seat 105 is configured to support three smaller passengers, such as children or middle schoolers. Other uses of the seat 105 will be apparent with reference to discussion of the embodiments contained below. The modular design of the housing 125 allows for different seating options depending on the intended use of the vehicle and/or applicable safety standards, such as FMVSS 222. For example, the seat 105 and the seat assembly 100 depicted in FIG. 1, when used in a school bus, utilize compartmentalization to ensure the safety of passengers during a crash. Said differently, the narrow row spacing and height of the seat assembly 100 protect passengers during an accident. Other embodiments provide additional safety features in addition to compartmentalization.

FIG. 2 depicts another embodiment of a seat back 210 that can be incorporated into the seat assembly of FIG. 1. The seat back 210 is configured to attach to the seat bottom 115, as discussed with reference to FIG. 1, to define a seat 105 and another embodiment of a seat assembly 100. The seat back 210 includes another embodiment of a panel 220 attached to the housing 125 of the present disclosure. In this embodiment, the panel 220 includes two lateral buckle openings 225 and a central buckle opening 230. In this embodiment, the lateral buckle openings 225 and the central buckle openings 230 have a generally rectangular shape. In other embodiments, the lateral buckle openings 225 and the central buckle opening 230 have different shapes. The first lateral buckle opening 225 is located towards the isle side of the seat back 210, while the second lateral buckle opening 225 is located opposite the first lateral buckle opening 225 (i.e., towards the window). As shown, the central buckle opening 230 is offset towards the second lateral buckle opening 225. In other examples, the central buckle opening 230 is offset towards the first lateral buckle opening 225. The lateral buckle openings 225 and the central buckle opening 230 are configured to provide access to buckles assemblies located in the seat back 210 (discussed in more detail below). The lateral buckle openings 225 and the central buckle opening 230 include notches 235. The notches 235 are configured to receive buckle assemblies via, for example, a fastener. As shown in FIG. 2, the notches 235 have an arch shape. In other embodiments, the notches 235 have different shapes. The seat back 210 also includes a child safety seat opening 240. As illustrated, the child safety seat opening 240 has a rectangular shape. In other embodiments, the child safety seat opening 240 has a different shape. The child safety seat opening 240 is configured to allow access to a child safety seat inserted in the seat back 210. In this embodiment, the child safety seat opening 240 is located between the first lateral buckle opening 225 and the central buckle opening 230, but the child safety seat opening 240 slightly offset towards the first lateral buckle opening 225. In other embodiments, the child safety seat opening 240 is slightly offset towards the central buckle opening 230. In yet further embodiments, the child safety seat opening 240 is located between the second lateral buckle opening 225 and the central buckle opening 230 and the central buckle opening 230 is offset towards the first lateral buckle opening 225.

The panel 220 depicted in FIG. 2 is configurable to provide a seat 105 to passengers of various sizes and ages. For example, the seat 105 defined by the seat back 210 and the seat bottom 115 allow for one, two, or three passengers, depending on their individual sizes. Further, up to three passengers can be securely fastened to the seat assembly 100 via buckles accessed through the lateral buckle openings 225 and the central buckle opening 230. The panel 220 also provides a child safety seat contained within the seat back 210 and accessible through the child safety seat opening 240. In some embodiments, the seat 105 is configurable to secure a child to the seat assembly 100. In other embodiments, the seat 105 is configured such that the child safety seat is flush with the panel 220 so an adult passenger can be seated in the seat 105 where the child safety seat opening 240 is located.

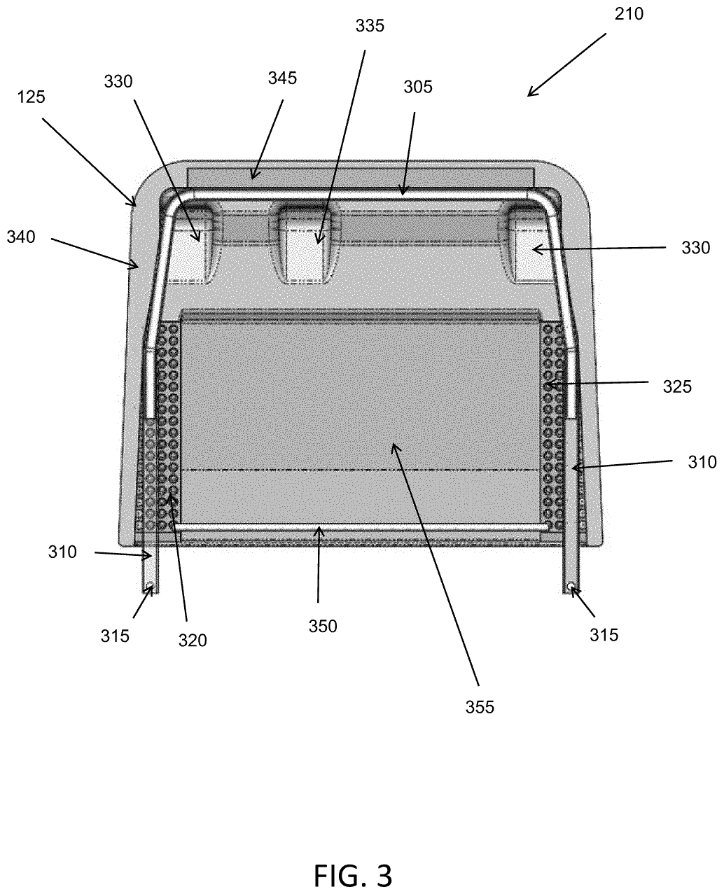

FIG. 3 depicts a cross-sectional front view of the seat back 210 illustrated in FIG. 2 with the panel 220 removed for ease of illustration. As shown, the seat back 210 includes a frame 305. The frame 305 generally has the same shape as the housing 125 and extends along the perimeter of the housing 125, except for the portion of the housing 125 that extends transverse to the seat bottom 115. The frame 305 is configured to provide structural support to the seat back 210. In other examples, the frame 305 has a generally rectangular shape that extends and supports the entire perimeter of the seat back 210, including the portion of the perimeter that extends transverse to the seat bottom 115. The frame 305 includes mounting legs 310. In this embodiment, the mounting legs 310 are securely attached to the frame 305, for example, via fasteners. In other examples, the frame 305 and the mounting legs 310 are made from one continuous piece of material. The mounting legs 310 are configured to attach the frame 305, and therefore, the seat back 210, to the cushion 130 and/or mounting pedestals 135 via apertures 315, thus securing the seat back 210 to the vehicle. The mounting legs 310 do not allow for the angle between the seat back 210 and the seat bottom 115 to be altered by passengers and/or an operator of the vehicle.

The seat back 210 further includes two mounting posts 320. The mounting posts 320 are generally parallel to one another and located on the isle side and window side of the seat back 210, respectively. The mounting posts 320 include a plurality of fastener mounting locations 325. The fastener mounting locations 325 are configured to receive various shapes, sizes, and types of fasteners. Said differently, the fastener mounting locations 325 are configured as universal mounting locations configured to accept and secure various types of fasteners. The frame 305 and/or the mounting legs 310 are configured to attach to at least one of the fastener mounting locations 325 on the mounting posts 320. Attachment of the frame 305 and/or the mounting legs 310 to the mounting posts 320 via the fastener mounting locations 325 secures the frame 305 and the mounting legs 310 to the housing 125 of the seat back 210. In some embodiments, the mounting posts 320 are configured as crumple zones. As such, the mounting posts 320 are configured to deform and absorb the impact force imparted on the seat assembly 100 in the event of an accident. This allows the frame 305 and the mounting legs 310 to retain their structure in order to provide adequate protection to passengers through compartmentalization.

The housing 125 includes two lateral buckle mounting locations 330 and a central buckle mounting location 335. The first lateral buckle mounting location 330 is located towards the isle side of the seat back 210, while the second lateral buckle mounting location 330 is located opposite the first lateral buckle mounting location 330 (i.e., towards the window). As shown, the central buckle mounting location 335 is offset towards the second lateral buckle mounting location 330. In other examples, the central buckle mounting location 335 is offset towards the first lateral buckle mounting location 330. The lateral buckle mounting locations 330 and the central buckle mounting location 335 of the housing 125 are selectively outfitted with buckle assemblies to secure a passenger to the seat 105. In this embodiment, the housing 125 is configured as such that both the lateral buckle mounting locations 330 and the central buckle mounting location 335 are outfitted with buckle assemblies, as the panel 220 includes two lateral buckle openings 225 and the central buckle opening 230 in order to access the buckle assemblies. The housing 125 also includes an inner surface 340. The inner surface 340 defines the portion of the housing 125 that the panel 220 is attached to. For example, during manufacturing, adhesives are applied to the inner surface 340 of the housing 125 and the panel 220 is attached thereto. A portion of the inner surface 340 defines a head absorbing portion 345. The head absorbing portion 345 is an energy absorbing portion configured to reduce the force of impact felt by a passenger of the vehicle in the event of an accident. The head absorbing portion 345, in one example, is made of foam. In other examples, the head absorbing portion 345 is made of EPS and/or EPP. As shown, the head absorbing portion 345 is an insert that attaches to the housing 125 within a portion of the inner surface 340. In other embodiments, the head absorbing portion 345 is integrally formed as part of the housing 125 during manufacturing.

The seat back 210 includes a support beam 350. The support beam 350 extends between and is connected to both of the mounting posts 320. The support beam 350 is configured to provide additional structural support for the seat back 210. Attachment of the panel 220 to the housing 125 defines a cavity 355. The support beam 350 further is configured to secure and support material inserted into the cavity 355. For example, in this embodiment, a child safety seat is inserted into the cavity 355 and supported by the support beam 350. In other examples, the cavity 355 houses an insert to provide additional comfort and support for passengers. The insert in some embodiments is made of foam, in other embodiments the insert is made of EPS and/or EPP made. In yet other examples, the cavity 355 is injected with foam after assembly of the seat back 210.

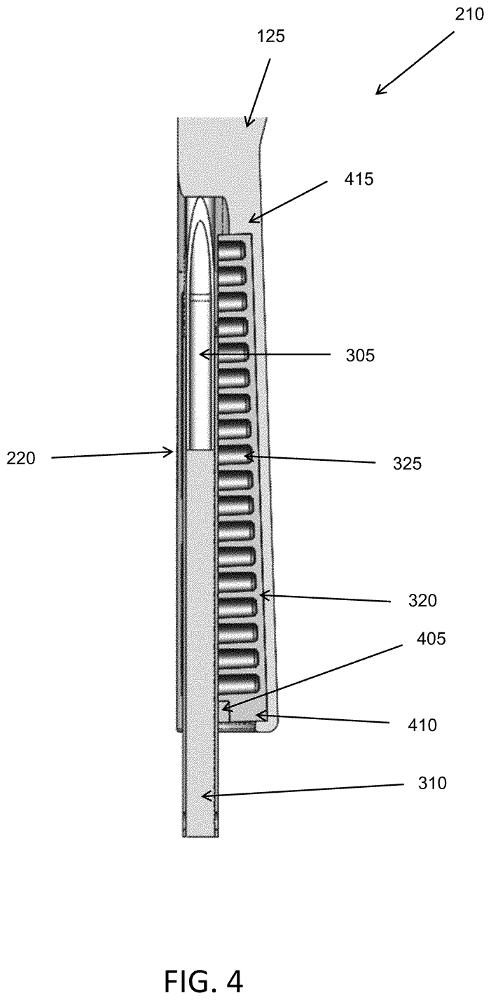

FIG. 4 is a cross-sectional side view of the seat back 210 illustrated in FIG. 2. As shown, the seat back 210 is assembled and ready to be secured to the cushion 130 and/or mounting pedestals 135 of the seat bottom 115. The panel 220 is attached to the housing 125 with the frame 305 disposed between the panel 220 and the housing 125. As discussed previously, the frame 305 is attached to the mounting leg 310. Further, the frame 305 and/or the mounting leg 310 are attached to at least one of the fastener mounting locations 325 of the mounting post 320 via one or more fasteners. The mounting post 320 is operatively connected to the housing 125. In this embodiment, the housing 125 includes a ledge 405 and a corner 410. The mounting post 320 includes a flange 415. The mounting post 320 is insertable between the ledge 405 and the corner 410. More specifically, the flange 415 of the mounting post 320 is inserted in between the housing 125 and the ledge 405 and the opposite end of the mounting post 320 is inserted into the housing 125 near the corner 410. Said differently, the mounting post 320 is secured to the housing 125 by friction fit by inserting the flange 415 next to the ledge 405 and inserting the opposite end near the corner 410. In another example, the mounting post 320 is secured to the housing 125 via adhesives. In other examples, the mounting post 320 is secured to the housing 125 by fasteners. In yet other examples, combinations of these methods are used.

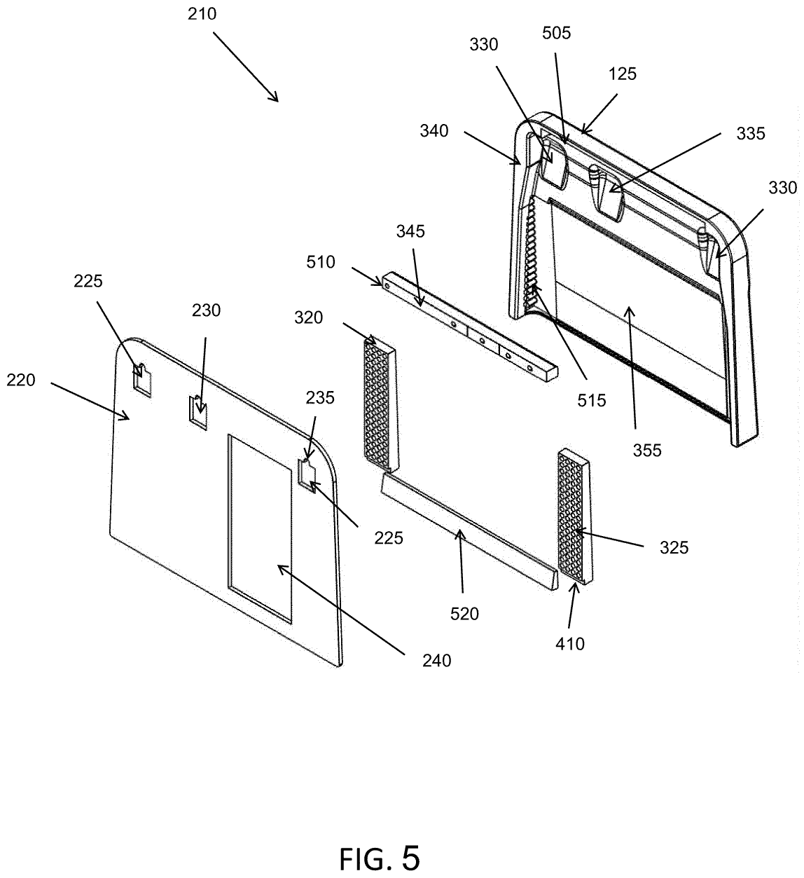

FIG. 5 is an exploded view of the seat back 210 from FIG. 2. As shown, the inner surface 340 of the housing 125 defines a cavity 505 configured to house and receive the head absorbing portion 345. In the embodiment of the head absorbing portion 345 shown, the head absorbing portion 345 is housed within the cavity 505 and secured to the housing 125 via fasteners attached through a plurality of apertures 510. In other examples, the head absorbing portion 345 is secured within the cavity 505 of the inner surface 340 via adhesives and/or friction. The housing 125 further includes padding 515. The padding 515 is located on the interior of the housing 125 adjacent to the mounting posts 320. The padding 515 is configured to absorb and minimize the impact force felt by a passenger in the event of an accident. In one example the padding 515 is made of foam. In other examples, the padding 515 is made of EPS and/or EPP. In this embodiment, the seat back 210 includes a knee absorbing portion 520. The knee absorbing portion 520 in attached within the cavity 355 of the seat back 210. The knee absorbing portion 520 is an energy absorbing portion like the head absorbing portion 345. For example, the head absorbing portion 345 and the knee absorbing portion 520 are configured to minimize the impact force felt by a passenger during an accident. The head absorbing portion 345 minimizes the force of an impact in the event a passenger hits their head on the seat assembly 100, while the knee absorbing portion 520 minimizes the impact force felt by a passenger in the event of a crash if their knees hit the seat assembly 100 of the row in front of where they are seated. However, the knee absorbing portion 520 is located opposite the head absorbing portion 345, is disposed between the housing 125 and the panel 220, and extends transverse to the cushion 130 of the seat bottom 115. Said differently, the knee absorbing portion 520 extends perpendicularly between the mounting posts 320 near the ledge 405 of the housing 125. In this embodiment, the knee absorbing portion 520 is attached to the housing 125 via adhesives. In other examples, the knee absorbing portion 520 is secured by a support beam 350. The knee absorbing portion 520 is made of foam. In other examples, the knee absorbing portion 520 is made of EPS and/or EPP. It should be appreciated that the head absorbing portion 345 and the knee absorbing portion 520 do not need to be made of the same material. Although FIG. 5 is illustrated as having both a head absorbing portion 345 and a knee absorbing portion 520, other embodiments include either the head absorbing portion 345 or the knee absorbing portion 520 or neither.

During assembly of the seat back 210 illustrated in FIG. 5, the head absorbing portion 345 is inserted and secured within the cavity 505 of the housing 125. The mounting posts 320 are inserted and secured to the housing 125 via the ledge 405, the corner 410, and the flange 415, as discussed previously with reference to FIG. 4. The knee absorbing portion 520 is inserted into the cavity 355 of the housing 125 and secured thereto, for example, via adhesives. In this embodiment, buckle assemblies are attached and secured to the lateral buckle mounting locations 330 and the central buckle mounting location 335 of the housing 125 of the seat back 210. Additionally, a child safety seat is inserted and secured within the cavity 355 of the housing 125. In some embodiments, a force absorbing material is inserted into the cavity 355 of the housing 125 in the empty space remaining after the child safety seat is inserted. The mounting legs 310 are attached the frame 305 and/or the fastener mounting locations 325 of the mounting posts 320. Additionally, the frame 305 is attached to the fastener mounting locations 325 of the mounting posts 320. Adhesives are applied to the inner surface 340 of the housing 125 and the panel 220 is secured to the inner surface 340 of the housing 125. As such, the buckles assemblies, child safety seat, the head absorbing portion 345, the mounting posts 320, the knee absorbing portion 520, the frame 305, and the mounting legs 310 are disposed between the housing 125 and the panel 220. The lateral buckle openings 225 of the panel 220 and the lateral buckle mounting locations 330 of the housing 125 are configured such that attachment of the panel 220 to the housing 125 aligns the lateral buckle openings 225 with the lateral buckle mounting locations 330. Further, the central buckle opening 230 and the central buckle mounting location 335 are configured to align after attachment of the panel 220 to the housing 125. As such, the buckle assemblies are accessible via the lateral buckle openings 225 and the central buckle opening 230. Additionally, during assembly of the seat back 210, the child safety seat is inserted into the housing 125 such that it is aligned with the child safety seat opening 240 of the panel 220. As such, the child safety seat is accessible via the child safety seat opening 240. Optionally, after assembly of the seat back 210, in some embodiments, the space of the cavity 355 remaining after assembly is injected with a force absorbing material. The force absorbing material is configured to reduce the amount of impact force imparted on a passenger in the event of an accident. The force absorbing material in some embodiments is foam. In other embodiments the force absorbing material is EPS and/or EPP.

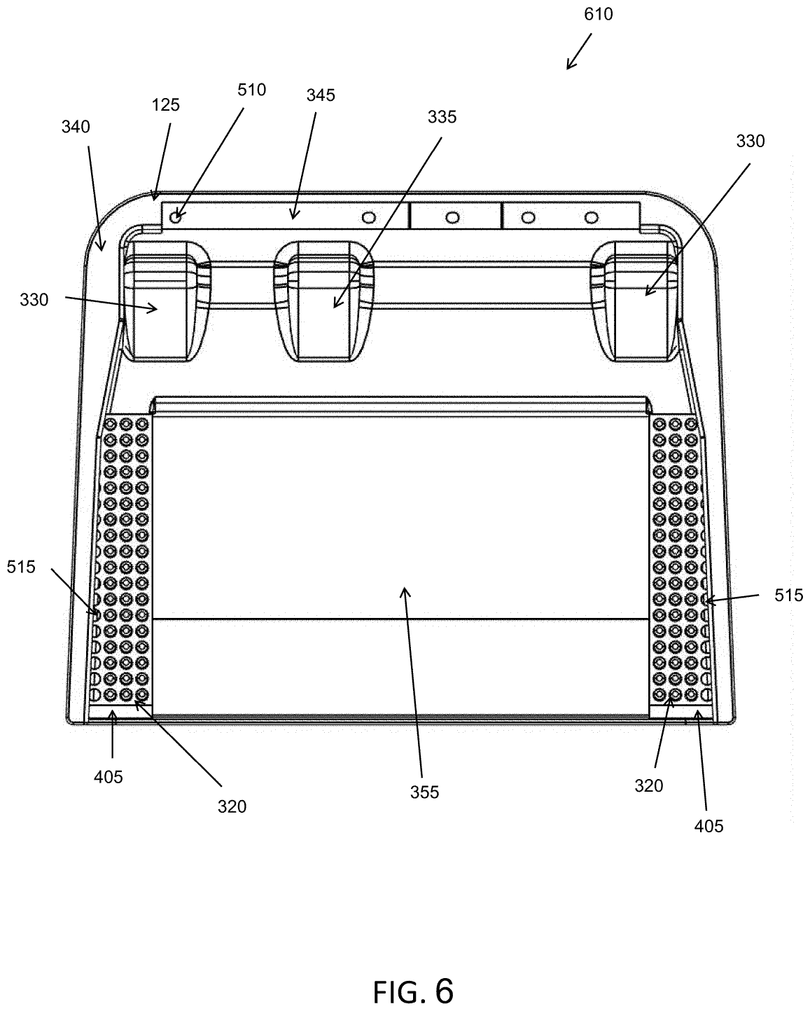

FIG. 6 is a front view of a seat back 610 that can be incorporated into the seat assembly of FIG. 1. The seat back 610 includes the housing 125. In this embodiment, the seat back 610 further includes the head absorbing portion 345, which has been inserted into the cavity 505 of the inner surface 340 and secured via fasteners secured through the plurality of apertures 510. Further, the mounting posts 320 are secured within the housing 125 of the seat back 610 via the ledges 405, the corners 410, and the flanges 415, adjacent to the padding 515. At this point during assembly, the modular nature of the housing 125 allows for slight variations in the assembly of the seat back 610 to accommodate different designs of the panel 120 (as shown in FIGS. 1, 2, 14, 15, 16, 17, and 18). For example, one, both or neither of the lateral buckle mounting locations 330 and/or the central buckle mounting location 335 can be outfitted with buckle assemblies, as necessary. Further, one or more child safety seats can be inserted into the cavity 355, as necessary. Additionally, force absorbing material can be inserted into the cavity 355, as necessary or as desired. As such, various embodiments of the seat assembly 100 are outfitted with different safety equipment, such as buckle assemblies and/or child safety seats, while utilizing the housing 125 of the present disclosure.

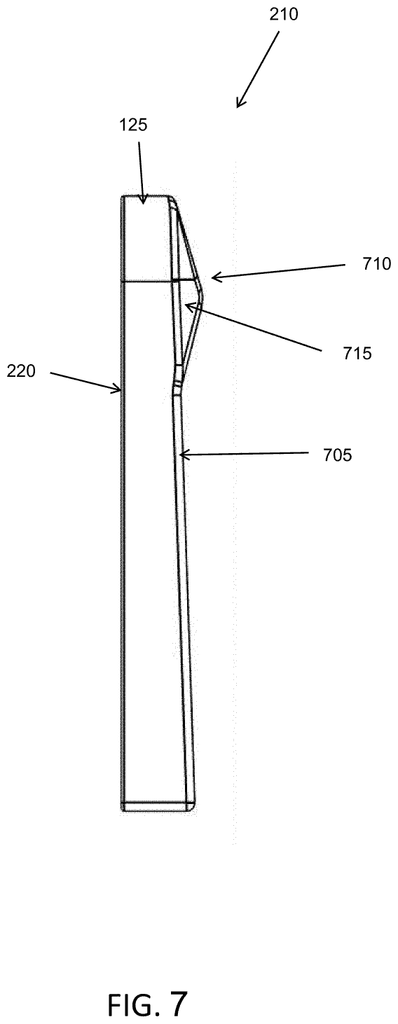

FIG. 7 illustrates a side view of the seat back 210 depicted in FIG. 2. As shown, the panel 220 is attached to the housing 125. The housing 125 includes an outer surface 705. The outer surface 705 includes a protruding portion 710. The protruding portion 710 may be configured for a number of different uses. In one embodiment, the protruding portion 710 defines a cavity 715 in the interior of the seat back 210. In one example, the cavity 715 provides extra room for the placement of safety features, such as one or more buckle assemblies. In another example, the cavity 715 defined by the protruding portion 710 includes additional force absorbing material. The force absorbing material may be foam, expanded polystyrene, or expanded polypropylene. In some embodiments, the force absorbing material is injected into the protruding portion 710 of the housing 125 after assembly of the seat back 210.

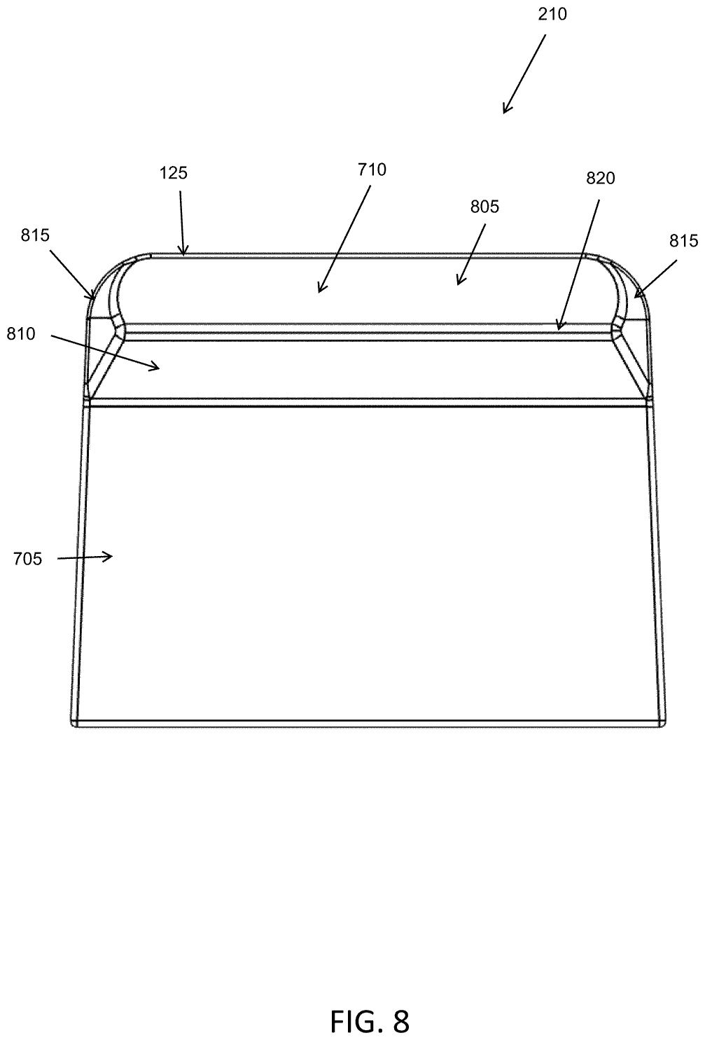

FIG. 8 depicts a rear view of the seat back 210 illustrated in FIG. 2. As illustrated, the protruding portion 710 includes a headrest portion 805, a support portion 810, and lateral portions 815 converge at an apex 820. In some embodiments, the protruding portion 710 is rigid and is therefore self-supporting. In other embodiments, the protruding portion 710 may be supported by internal framework of the seat back 210 and/or the housing 125. Further, in other embodiments, the protruding portion 710 may take other shapes, may be located generally towards the seat bottom 115, or may occupy a larger area of the outer surface 705 of the seat back 210. However, it should be appreciated that regardless of the embodiment of protruding portion 710 implemented, the housing 125 retains its unique modular structure such that various embodiments of panels 120 are attachable to the housing 125.

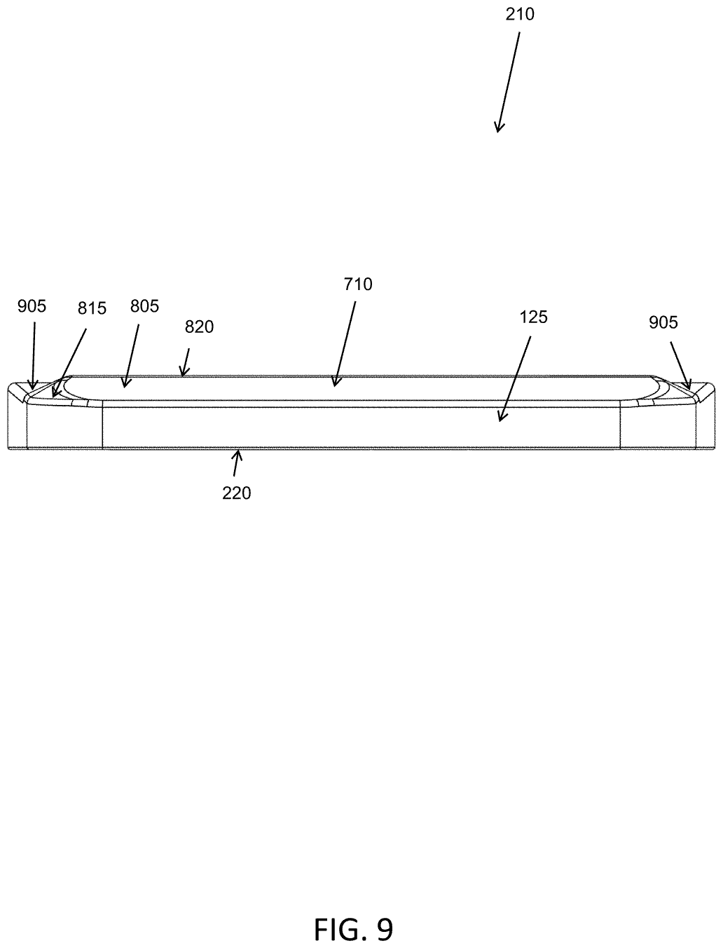

FIG. 9 depicts a top view of the seat back 210 from FIG. 2. The housing 125 includes the protruding portion 710 formed as part of the outer surface 705 of the housing 125, as discussed with reference to FIG. 7. The outer surface 705 of the seat back 210 includes edges 905 that taper generally away from the panel 220 of the seat back 210. In other examples, the edges 905 of the outer surface 705 have a generally flat shape that are generally perpendicular relative to the panel 220. In yet other examples, the outer surface 705 includes edges 905 that taper generally towards the panel 220 of the seat back 210.

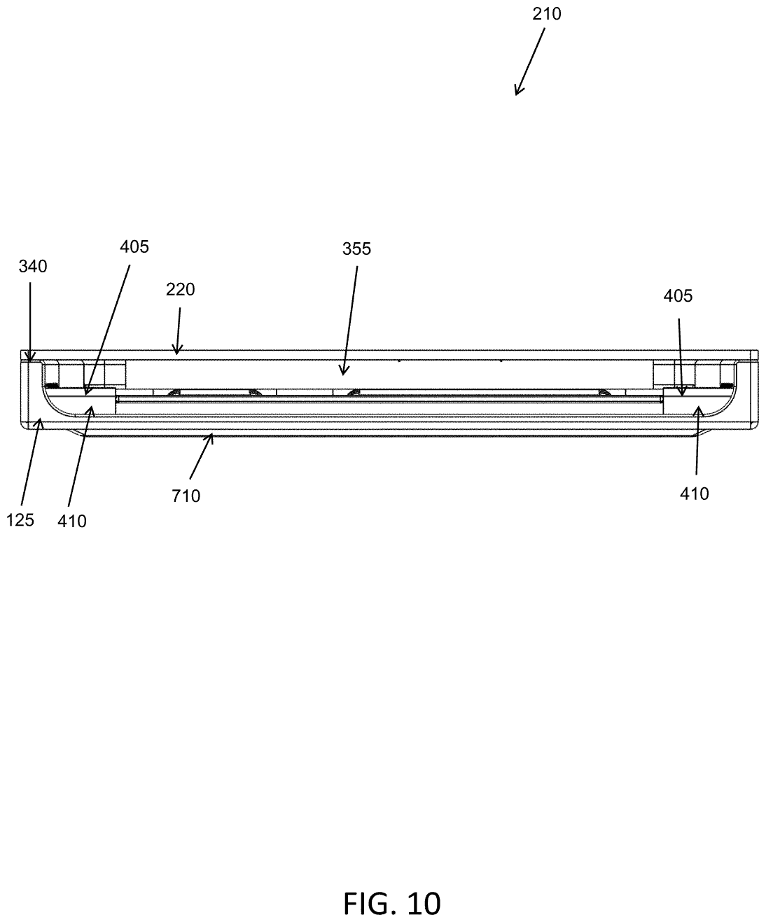

FIG. 10 is a bottom view of the seat back 210 depicted in FIG. 2. In this embodiment, the mounting posts 320 are installed in the seat back 210 by inserting the corners 410 of the mounting posts 320 into the ledges 405 of the housing 125. Further, the panel 220 is attached to the housing 125 via adhesives applied to the inner surface 340 of the housing 125. From this angle, the cavity 355 of the seat back 210 is visible as the cavity 355 is disposed between the panel 220 and the housing 125 of the seat back 210. In this embodiment, the seat back 210 includes a child safety seat inserted in the cavity 355. In other embodiments, a second child safety seat or no child safety seat are inserted into the cavity 355. In yet other embodiment, a force absorbing material is inserted into the cavity 355 to reduce the impact force imparted on a passenger during an accident.

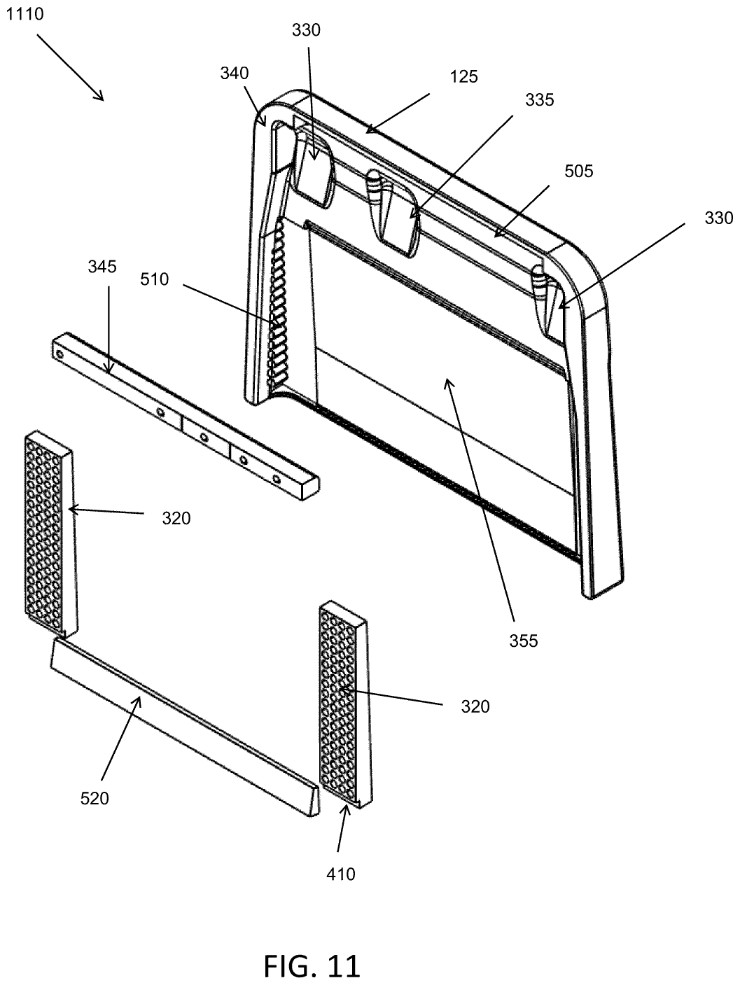

FIG. 11 is a zoomed in, exploded view of a seat back 1110 that can be incorporated into the seat assembly of FIG. 1. In this embodiment, the seat back 1110 includes the housing 125. The seat back 1110 further includes the head absorbing portion 345, the mounting posts 320, and the knee absorbing portion 520. As illustrated by the seat back 610 and the seat back 1110, the housing 125 is configured to include various configurations of component parts. As such, slight variations in the manufacturing process allow for seat assemblies 100 of different designs that allow the manufacturer to implement appropriate seats 105 based on the intended passengers of the vehicle. For example, manufacturing a seat 105 intended to securely fasten one or more children thereto does not require significant deviations in the manufacturing process of the seat assembly 100.

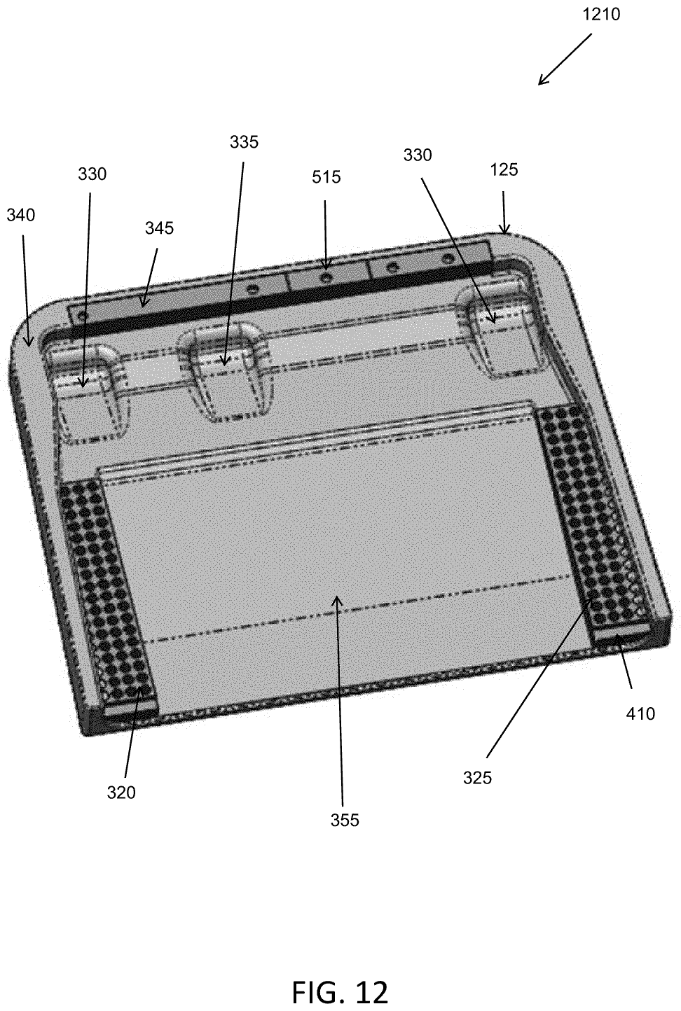

FIG. 12 illustrates another embodiment of a seat back 1210 that can be incorporated into the seat assembly of FIG. 1. The seat back 1210 includes the housing 125. Further, the seat back 1210 includes the head absorbing portion 345 secured to the inner surface 340 of the housing 125 via the plurality of apertures 510 and a plurality of fasteners. The seat back 1210 further includes the mounting posts 320 secured to the housing 125. The mounting posts 320 still include the corners 410. However, in this embodiment, the mounting posts 320 are secured to the housing 125 via one or more the of fastener mounting locations 325. In this embodiment, the seat back 1210 does not include the ledges 405.

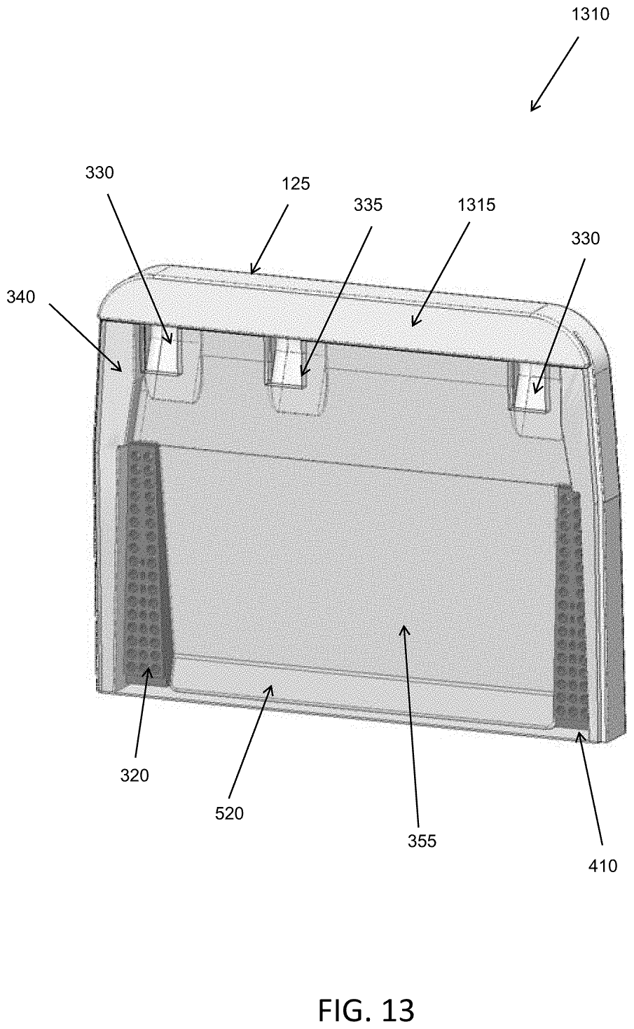

FIG. 13 illustrates another embodiment of a seat back 1310 that can be incorporated into the seat assembly of FIG. 1. In this embodiment, the seat back 1310 includes mounting posts 320 and the knee absorbing portion 520. The seat back 1310 further includes an overhanging shroud 1315. The overhanging shroud 1315 is configured to provide an additional layer of force absorbing material. As such, the overhanging shroud 1315 in some embodiments is made of foam. In other embodiments, the overhanging shroud 1315 is made of EPS and/or EPP. The seat back 1310 further includes the head absorbing portion 345 located beneath the overhanging shroud 1315. Thus, the overhanging shroud 1315 provides additional protections for the head of a passenger in the event of an accident. This is especially true in the event of whiplash. In some embodiments, the overhanging shroud 1315 and the housing 125 are manufactured from a single piece of material. In other embodiments, the overhanging shroud 1315 and the housing 125 are a single molded component. In yet other embodiments, the overhanging shroud 1315 is attached to the housing 125 during the manufacturing process, for example, by adhesives.

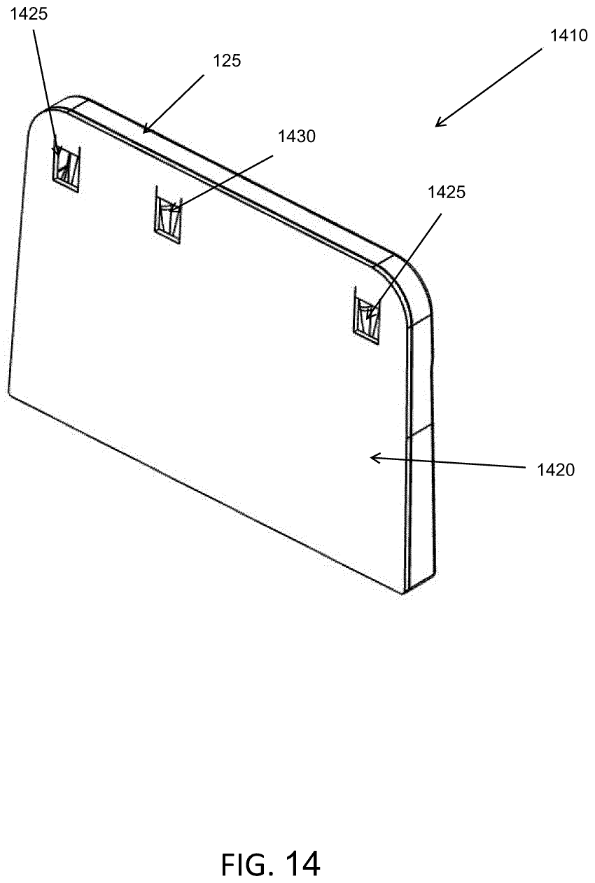

FIG. 14 illustrates another embodiment of a seat back 1410 that can be incorporated into the seat assembly of FIG. 1. The seat back 1410 includes another embodiment of a panel 1420 and the housing 125. In this embodiment, the panel 1420 includes two lateral buckle openings 1425 and a central buckle opening 1430. As illustrated, the lateral buckle openings 1425 and the central buckle opening 1430 have a rectangular shape. In other embodiments, the lateral buckle openings 1425 and the central buckle opening 1430 have a different shape. The first lateral buckle opening 1425 is located towards the isle side of the seat back 1410, while the second lateral buckle opening 1425 is located opposite the first lateral buckle opening 1425 (i.e., towards the window). As shown, the central buckle opening 1430 is offset towards the second lateral buckle opening 1425. The lateral buckle openings 1425 and the central buckle opening 1430 are configured to provide access to the interior of the seat back 1410. Specifically, the lateral buckle openings 1425 and the central buckle opening 1430 provide access to buckle assemblies (as discussed previously with reference to the lateral buckle openings 225 and the central buckle opening 230). In this embodiment, the housing 125 is outfitted with buckle assemblies at the lateral buckle openings 1425 and the central buckle opening 1430 during manufacturing. In some embodiments, the cavity 355 of the seat back 1410 is filled with a force absorbing material, as discussed previously.

As designed, the seat 105 of the seat back 1410 is configured to seat a variety of passenger combinations. Said differently, the seat 105 of the seat back 1410 is configured to seat three medium-sized passengers, such as middle schoolers, a mid-size passenger and a full-grown passenger, such as a high schooler or an adult, or two full-grown passengers.

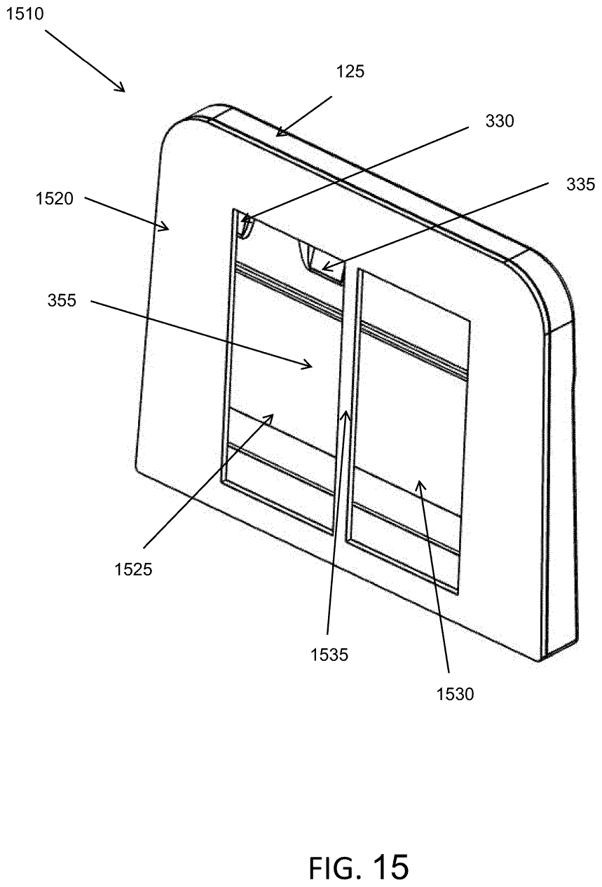

FIG. 15 illustrates another embodiment of a seat back 1510 that can be incorporated into the seat assembly of FIG. 1. The seat back 1510 includes another embodiment of a panel 1520 and the housing 125. In this embodiment, the panel 1520 includes a first child safety seat opening 1525 and a second child safety seat opening 1530. As illustrated, the child safety seat opening 1525 and the child safety seat opening 1530 have a rectangular shape. In other embodiments, the child safety seat opening 1525 and the child safety seat opening 1530 have a different shape. The first child safety seat opening 1525 is located towards the isle side of the seat back 1510, while the second child safety seat opening 1530 is located opposite the first child safety seat opening 1525 (i.e., towards the window). During manufacturing, two child safety seats are inserted into the cavity 355 and secured to the housing 125 of the seat back 1510. The child safety seat opening 1525 and the child safety seat opening 1530 are configured to provide access to the child safety seats disposed between the panel 1520 and the housing 125. In some embodiments, the seat back 1510 is configurable to secure two child passengers to the seat 105 of the seat back 1510. In other embodiments the aperture 510 is configured to support an adult passenger and securely support a child passenger or securely support two child passengers. The panel 1520 includes and the child safety seat opening 1525 and the child safety seat opening 1530 are separated by a divider 1535. As depicted, the divider 1535 and the panel 1520 are manufactured from a single piece of material. In other embodiments, the panel 1520 and the divider 1535 are a single molded component. In yet other embodiments, the divider 1535 is attached to the panel 1520 during the manufacturing process, for example, by adhesives.

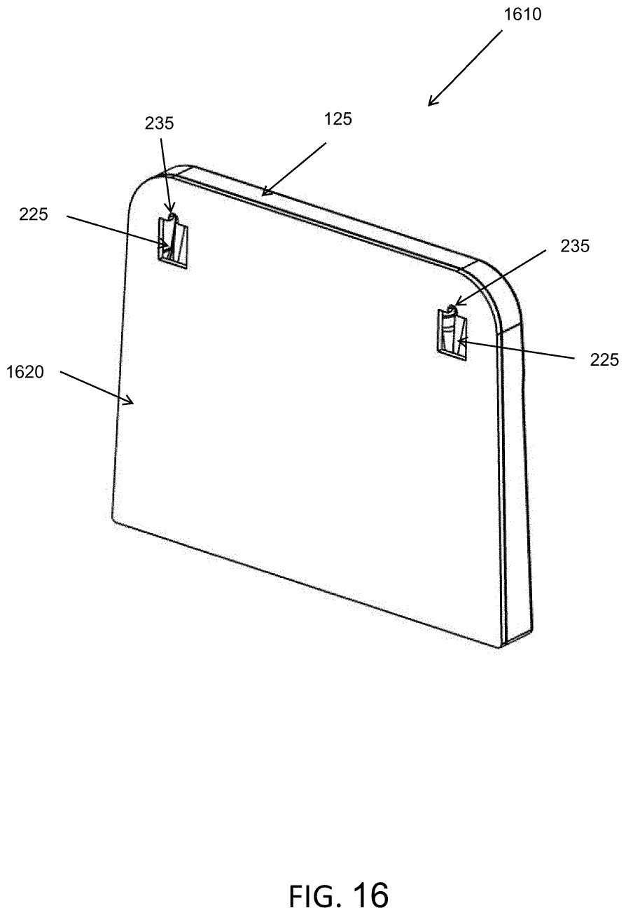

FIG. 16 depicts yet another embodiment of a seat back 1610 that can be incorporated into the seat assembly of FIG. 1. Again, the seat back 1610 includes another embodiment of a panel 1620 and the housing 125. In this embodiment, the panel 1620 includes two lateral buckle openings 225. The first lateral buckle opening 225 is located towards the isle side of the seat back 1610, while the second lateral buckle opening 225 is located opposite the first lateral buckle opening 225 (i.e., towards the window). During manufacturing and assembly, the lateral buckle mounting locations 330 of the housing 125 are outfitted with buckle assemblies. As such, the buckle assemblies are accessible via the two lateral buckle openings 225. In this embodiment, the lateral buckle openings 225 include notches 235. The seat back 1610 is therefore configured to secure two passengers to the seat 105 of the seat back 1610. The buckle assemblies attached to the lateral buckle mounting locations 330 of the housing 125 and accessible through the lateral buckle openings 225 of the panel 1620 can be used in conjunction with external child safety seats such that the seat 105 is configurable to secure a child to the seat 105 defined by the seat back 1610. Again, the cavity 355 disposed between the panel 1620 and the housing 125, in some embodiments, includes the force absorbing materials.

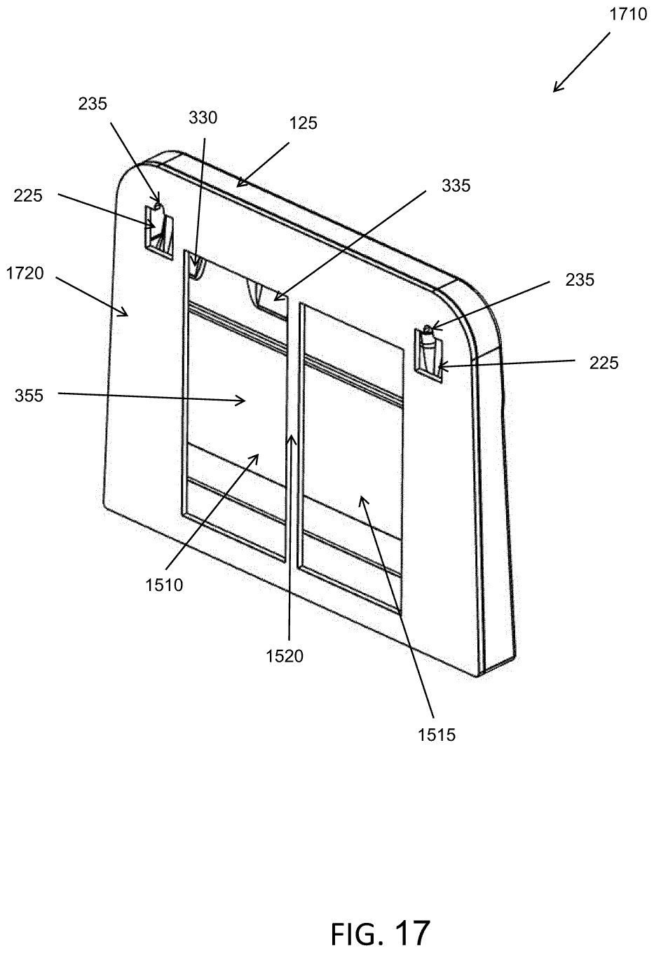

FIG. 17 is a perspective view of yet another embodiment of a seat back 1710 that can be incorporated into the seat assembly of FIG. 1. The seat back 1710 further includes another embodiment of a panel 1720 attached to the housing 125. In this embodiment, the panel 1720 includes two lateral buckle openings 225. The first lateral buckle opening 225 is located towards the isle side of the seat back 1710, while the second lateral buckle opening 225 is located opposite the first lateral buckle opening 225 (i.e., towards the window). During manufacturing and assembly, the lateral buckle mounting locations 330 of the housing 125 are outfitted with buckle assemblies. As such, the buckle assemblies are accessible via the two lateral buckle openings 225. The lateral buckle openings 225 of the panel 1720 include notches 235. Although the housing 125 includes the central buckle mounting location 335, the central buckle mounting location 335 is not outfitted with a buckle assembly during manufacturing, as the panel 1720 does not provide access to the central buckle mounting location 335. The panel 1720 further includes the first child safety seat opening 1525 and the second child safety seat opening 1530. The first child safety seat opening 1525 is located towards the isle side of the seat back 1710, while the second child safety seat opening 1530 is located opposite the first child safety seat opening 1525 (i.e., towards the window). The panel 1720 includes and the child safety seat opening 1525 and the child safety seat opening 1530 are separated by the divider 1535. During manufacturing, two child safety seats are inserted into the cavity 355 and secured to the housing 125 of the seat back 1710. The child safety seat opening 1525 and the child safety seat opening 1530 are configured to provide access to the child safety seats disposed between the panel 1720 and the housing 125. With this configuration, the seat back 1710 is configured to seat two passengers wherein either one or both seats are configurable to secure a child to the seat 105 of the seat back 1710. Alternatively, the seat 105 defined by the seat back 1710 configurable to secure an external child safety seat to the seat back 1710 and the cushion 130, if desired.

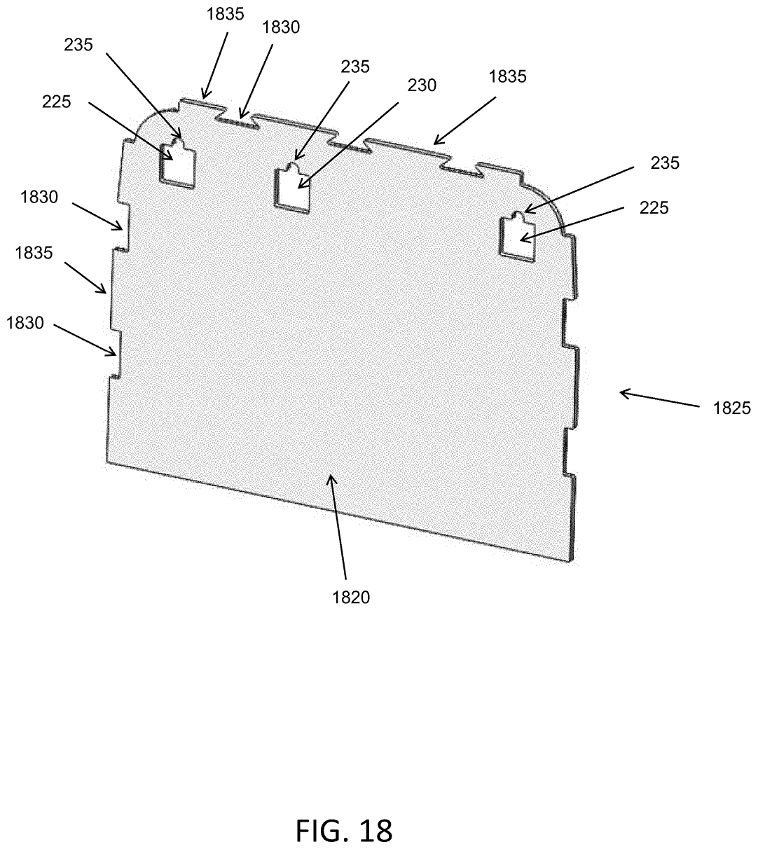

FIG. 18 illustrates an alternative embodiment of a panel 1820 that can be incorporated into the seat assembly of FIG. 1. FIG. 18 also represents an alternative attachment mechanism to secure the panel 1820 to the housing 125. The panel 1820 includes two lateral buckle openings 225 and the central buckle opening 230. Further, the lateral buckle openings 225 and the central buckle opening 230 include the notches 235. However, the panel 1820 includes a series of interlocking members 1825 along the perimeter of the panel 1820 where the panel 1820 aligns with the inner surface 340 of the housing 125. The series of interlocking members 1825 include both a plurality of recesses 1830 and a plurality of protrusions 1835. The series of interlocking members 1825 of the panel 1820 is configured to mate with a series of interlocking members located on the inner surface 340 of the housing 125. In some embodiments, the recesses 1830 and protrusions 1835 are dovetail-and-groove joints. In yet other embodiments, the recesses 1830 and the protrusions 1835 represent T-slot joints. However, as shown in FIG. 18, the series of interlocking members 1825 can be any shape configured to mate with a counterpart member on the inner surface 340 of the housing 125. Further, individual elements of the series of interlocking members 1825 do not need to have the same shape, connection, and/or joint. In this embodiment, the panel 1820 attaches to the housing 125 via the series of interlocking members 1825, which create a friction fit. In other embodiments, adhesives are applied to the recesses 1830 and/or the protrusions 1835 to securely affix the panel 1820 to the housing 125.

While specific reference to the methods of attachment of the panels 120 to the housing 125 have been discussed, it should be appreciated that the panels 120 are attached to the housing 125 in any suitable way. In some examples, the panel 120 is attached to the housing 125 via adhesives. In other examples, a series of interlocking members are used. In yet other examples, fasteners are used to attach the panel 120 to the housing 125. The examples provided herein are for illustrative purposes only and are not intended to be limiting.

It should be appreciated that other embodiments of panels 120 are also envisioned within the spirit of the present disclosure. For example, a panel 120 may include one lateral buckle opening 225 and one child safety seat opening 1525.

The modular design of the seat back 110 allows for various configurations of panels 120, as shown by the various embodiment illustrated in FIGS. 1, 2, 14, 15, 16, 17, and 18. This allows for different seating options depending on the intended use of the vehicle and/or applicable safety standards, such as FMVSS 222. For example, the seat 105 and the seat assembly 100 depicted in FIG. 1, when used in a school bus, utilize compartmentalization to ensure the safety of passengers during a crash. Said differently, the narrow row spacing and height of the seat assembly 100 protect passengers during an accident. The other embodiments employ combinations of buckle assemblies and child safety seats to provide additional safety features in addition to compartmentalization.

The modular design of the seat back 110 also allows for different configurations of seating arrangements in a vehicle. For example, if a school bus route requires the bus to transport children and high schoolers, alike, different rows can have different panels 120 to provide proper seating depending on the age of the passenger. Since the manufacturing process is not significantly changed, regardless of the embodiment of panel 120 used, the time and cost to outfit a school bus with different seating options is reduced. This allows for school bus seating to be customizable to the needs of the school bus or school district. As an example, rows of a school bus may be outfitted to seat older passengers further back on the bus. The front rows may implement the panel 120 as depicted in FIG. 17 to seat young children. The middle rows may utilize the panels 120 of FIG. 2 or 14 to securely support middle schoolers, for example, while the seats towards the back may utilize the panels 120 of FIG. 1 or 15 to accommodate high schoolers.

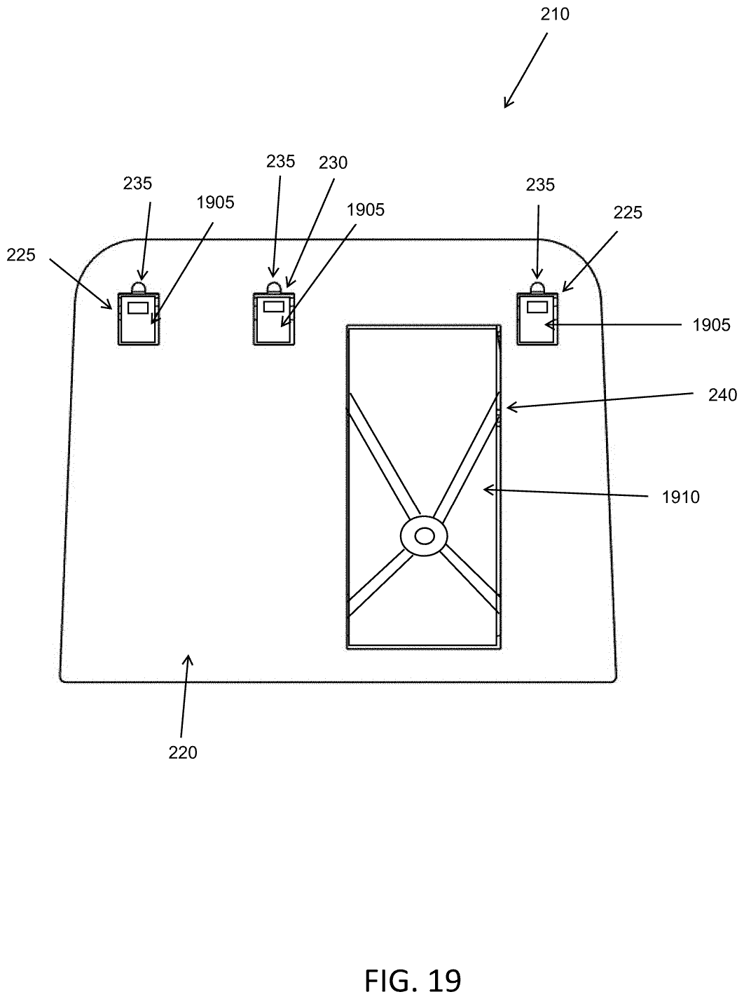

FIG. 19 illustrates a front view of the seat back 210 depicted in FIG. 2 with buckle assemblies 1905 and a child safety seat 1910 secured within the seat back 210. In this embodiment, the buckle assemblies 1905 are attached to the lateral buckle mounting locations 330 and the central buckle mounting location 335 of the housing 125. The buckle assemblies 1905 are accessible through the lateral buckle openings 225 and the central buckle opening 230 of the panel 220 to securely fasten a passenger to the seat 105. Further, in this embodiment, the child safety seat 1910 is secured within the cavity 355 of the seat back 210. The child safety seat 1910 is accessible through the child safety seat opening 240 of the panel 220 to securely fasten a child to the seat 105. In some embodiment, the child safety seat 1910 is configured to secure a child to the seat 105. In other embodiments, the child safety seat 1910 is configured to be flush with the panel 220 to allow an adult passenger to occupy the seat 105.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“Adhesive” generally refers to any non-metallic substance applied to one or both surfaces of two separate parts that binds them together and resists their separation. For example, an adhesive can bond both mating surfaces through specific adhesion (e.g., molecular attraction), through mechanical anchoring (e.g., by flowing into holes in porous surfaces), and/or through fusion (e.g., partial solution of both surfaces in the adhesive or its solvent vehicle). Some non-limiting examples of adhesives include liquid adhesives, film adhesives, resin adhesives, rubber adhesives, silicone-based adhesives, mastics, metal-to-metal adhesives, plastic adhesives, rubber adhesives, sprayable adhesives, and hot melt adhesives, to name just a few.

“Aftermarket Product” generally refers to one or more parts and/or accessories used in repair and/or enhancement of a product already made and sold by an Original Equipment Manufacturer (OEM). For example, aftermarket products can include spare parts, accessories, and/or components for motor vehicles.

“And/Or” generally refers to a grammatical conjunction indicating that one or more of the cases it connects may occur. For instance, it can indicate that either or both of two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Buckle” generally refers to device, such as in the form of a clasp, that releasably secures two or more loose ends together. Typically, but not always one end is secured to or otherwise attached to the clasp device, and the other end is releasably or adjustably held by the clasp device. The ends can be for a variety of objects such as straps, belts, cables, and webbing, to name just a few. One common type of buckle is a seat belt buckle found in a wide variety of vehicles. For instance, the buckle can be used in two-point, three-point, four-point, five-point, or six-point harness systems. In one example, the loose end of a seat belt is looped through a slot in a latch plate that includes a tongue, and to secure the loose end, the tongue is inserted into a seat belt buckle that is attached to a fixed seat belt or webbing.

“Buckle assembly” generally refers to the component parts that secure a passenger to a seat of a vehicle. For example, a typical buckle assembly includes a buckle, a clip, an adjustable turning loop, and a belt or webbing. A buckle assembly also includes two, three, and/or five-point restraint system.

“Cavity” generally refers to an empty space in a solid object. The cavity can be completely or partially surrounded by the solid object. For example, the cavity can be open to the surrounding environment.

“Channel” generally refers to a long, narrow groove in a surface of an object.

“Child Safety Seat”, “Car Seat”, or “Child Restraint System” generally refer to a seat that is specifically designed to protect children from injury during a vehicle collision. Commonly, the child safety seat is an aftermarket product that is installed by an owner into a vehicle after purchase of the vehicle, but the child safety seat can be also integrated into a seat of the vehicle by a manufacturer of the vehicle. In contrast to most vehicle seats, which are designed to accommodate adults, the child safety seat is sized and configured to properly position a child or infant to reduce injury during an accident. The child safety seat further typically includes a passive restraint system, such as a harness, that generally holds an occupant of the seat in place during a collision. The restraint system for example can include a five-point harness, but other types of harnesses and restraints can be used. When sold as a separate, aftermarket product, the child safety seat can include an anchoring mechanism, like an Isofix connecter, configured to secure the child safety seat to the vehicle (e.g., via an Isofix anchor in the vehicle). Some typical types of child safety seats include infant seats, convertible seats, combination seats, and booster seats, just to name a few.

“Cushion” generally refers to a padded support surface made of soft or semi-soft material, such as foam, configured to support a person in a seated or leaning position.

“Fastener” generally refers to a hardware device that mechanically joins or otherwise affixes two or more objects together. By way of non-limiting examples, the fastener can include bolts, dowels, nails, nuts, pegs, pins, rivets, screws, buttons, hook and loop fasteners, and snap fasteners, to just name a few.

“Feet” generally refers to a shaped or ornamented feature terminating a leg at the lower part of the leg.

“Floor” generally refers to the flat base panel of a vehicle where the support structures are mounted. The floor can be made of many different materials such as wood, plastics, metals, rubbers, or a combination of materials. The floor may have tracks or mounting brackets for mounting support structures that are flush with the rest of the floor and/or protrude above the standard floor height. The floor of a vehicle is also the primary area for storage as that is where the items are set. For example, when loading the back of a van, the groceries are typically set on the floor. Additionally, the floor may be covered in a material to make it more comfortable. Some materials used may be carpet, rubber, metals, or leathers.

“FMVSS 222” generally refers to the School Bus Passenger Seating and Crash Protection Standard FMVSS 222. The Standard establishes dimensional, strength, and impact protection requirements for school bus passenger seating and restraining barriers.

“Foam” generally refers to materials formed by trapping pockets of gas in a liquid or solid. Solid foams are generally categorized as open-cell-structured foams or closed-cell-structured foams. Open-cell-structured foams contain an interconnected network of pores, whereas closed-cell-structured foams do not have interconnected pores. Certain closed-cell-structured foams, sometimes called syntactic foam, contain hollow particles or beads embedded in the matrix of the material.

“Frame” generally refers to a structure that forms part of an object and gives strength and/or shape to the object.

“Front Panel” generally refers to the flat portion of the seat back that provides support and interfaces with the back of a passenger. The front panel is attachable to the rear panel of the seat back. The front panel is generally made of foam or foam-like material. Further, the front panel may be configured to include one or more buckle mounting locations, one or more seat belts, one or more buckles, or one or more child car seats.

“Mounted” means physically attached to or held in place by. This may be by fasteners, adhesives, conduits, brackets, over molded plastic, or otherwise.

“Mounting Pedestals” generally refers to the structure configured to support a seat. The mounting pedestals are generally attached to the seat bottom and/or the seat back and secure the seat to the vehicle. The mounting pedestals are generally formed of strong materials, such as alloys and metals. Any suitable number of mounting pedestals may be used to properly secure the seat bottom and seat back to the vehicle.

“Panel” generally refers to a flat or curved component that forms part of another object. Typically, but not always, the panel has a generally rectangular shape.

“Polypropylene Foam” generally refers to a substance in which pockets of gas are trapped in a synthetic aromatic polymer made from the monomer propylene. In other words, polypropylene foam generally refers to a multicellular expanded and/or extruded synthetic resinous material. The polypropylene material is typically, but not always, foamed with the aid of a blowing agent, such as chlorofluorocarbon (now typically banned due to environmental concerns), pentane, and/or carbon dioxide gas blowing agents, to name just a few examples, in order to form bubbles in the polypropylene foam. The term polypropylene foam is used in a broad context to include expanded polypropylene (EPP) and extruded polypropylene.

“Polystyrene Foam” generally refers to a substance in which pockets of gas are trapped in a synthetic aromatic polymer made from the monomer styrene. In other words, polystyrene foam generally refers to a multicellular expanded and/or extruded synthetic resinous material. The polystyrene material is typically, but not always, foamed with the aid of a blowing agent, such as chlorofluorocarbon (now typically banned due to environmental concerns), pentane, and/or carbon dioxide gas blowing agents, to name just a few examples, in order to form bubbles in the polystyrene foam. The trademark STYROFOAM® by Dow Chemical Company is commonly used to refer to all forms of polystyrene foam products. The term polystyrene foam is used in a broad context to include expanded polystyrene (EPS) and extruded polystyrene.

“Seat” generally refers to a type of support structure or a place constructed for the purpose of allowing a human and/or other animal to sit. Some examples of seats include chairs, stools, benches, saddles, and sofas to name just a few. Typically, but not always, the seat can further include a backrest, armrest, and a headrest as well as other features.

“Seat assembly” generally refers to all the component parts that make up a seat within a vehicle. A seat assembly generally includes a seat back and a seat bottom.

“Seat Back” generally refers to the portion of a seat intended to support the back of a passenger. The seat back generally includes a housing, a panel, and a frame. In some instances, the seat back is outfitted with safety features, such as buckle assemblies and/or child safety seats.

“Seat Belt”, “Safety Belt”, “Vehicle Belt”, or “Belt” generally refers to an arrangement of webs, straps, and other devices designed to restrain or otherwise hold a person or other object steady such as in a boat, vehicle, aircraft, and/or spacecraft. For example, the seat belt is designed to secure an occupant of a vehicle against harmful movement that may result during a collision or a sudden stop. By way of non-limiting examples, the seat belt can include webbing, buckles, latch plates, and/or length-adjustment mechanisms, such as a retractor, installed in the vehicle that is used to restrain an occupant or a child restraint system. The seat belt for instance can include a lap belt only, a combination lap-shoulder belt, a separate lap belt, a separate shoulder belt, and/or a knee bolster.

“Seat Bottom” generally refers to the portion of a seat that a passenger sits on and the mounting structure, such as mounting pedestals, for securing the seat assembly to the vehicle.

“Support Rod” generally refers to a component piece that connects the seat bottom to the seat back and generally allows for alteration of the angle between the seat back and seat bottom. The support rod allows for the seat back to be supported at different angles relative to the seat bottom.

“Thickness” generally refers to the measure of the distance between opposite sides of an object. As used here, the thickness of an object that is positioned between two surfaces is measured from between the two sides of the object that contact the surfaces.

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 seat assembly
105 seat
110 seat back
115 seat bottom
120 panel
125 housing
130 cushion
135 mounting pedestals
140 support rod
210 seat back
220 panel
225 lateral buckle opening
230 central buckle opening
235 notch
240 child safety seat opening
305 frame
310 mounting leg
315 aperture
320 mounting post
325 fastener mounting location
330 lateral buckle mounting location
335 central buckle mounting location
340 inner surface
345 head absorbing portion
350 support beam
355 cavity
405 ledge
410 corner
415 flange
505 cavity
510 aperture
515 padding
520 knee absorbing portion
610 seat back
705 outer surface
710 protruding portion
715 cavity
805 headrest portion
810 support portion
815 lateral portions
820 apex
905 edges
1110 seat back
1210 seat back
1310 seat back
1315 overhanging shroud
1410 seat back
1420 panel
1425 lateral buckle opening
1430 central buckle opening
1510 seat back
1520 panel
1525 child safety seat opening
1530 child safety seat opening
1535 divider
1610 seat back
1620 panel
1710 seat back
1720 panel
1820 panel
1825 interlocking members
1830 recesses
1835 protrusions
1905 buckle assemblies
1910 child safety seat

What is claimed is:

1. A system, comprising:
a bus seat including
a seat back including a housing and a panel secured to the housing,
wherein the panel and the housing define a cavity, and
wherein the housing is a unitary molded component configured to accept multiple different panel designs.

2. The system of claim 1, wherein the panel defines one or more openings.

3. The system of claim 2, wherein at least one of the openings is configured to provide access to a buckle assembly.

4. The system of claim 2, further comprising:
a frame coupled to the seat back; and
wherein the seat back and frame are arranged to have a geometry to promote energy absorption.

5. The system of claim 2, wherein:
the housing has a lip molded into the housing; and
the panel and the housing interlock with one another.

6. The system of claim 1, wherein the panel is adhered around an outer periphery of the panel to the housing via an adhesive.

7. The system of claim 1, wherein:
the panel and the housing are made of foam; and
the foam includes expanded polystyrene and/or expanded polypropylene.

8. The system of claim 1, wherein the housing includes one or more energy absorbing portions configured to absorb energy in the event of an accident.

9. The system of claim 1, wherein:
the cavity houses a knee insert to alleviate knee impacts; and
the cavity houses a head insert to alleviate head impacts.

10. A method, comprising:
molding a housing to form a back panel of a bus seat back; and
securing a front panel to the housing to create a cavity in the bus seat back.

11. The method of claim 10, further comprising:
adhering an outer periphery of the panel to the housing using adhesives.

12. The method of claim 10, further comprising:
attaching a mounting post into the housing; and
inserting a frame into the housing by attaching the frame to the mounting post.

13. The method of claim 10, further comprising:
wherein housing is a first housing;
wherein the front panel is a first front panel;
molding a second housing configured in a same fashion as the first housing;
securing a second front panel to the second housing; and
wherein the second front panel is constructed differently than the first front panel.

14. The method of claim 13, wherein the first front panel and the second front panel have different opening patterns.

15. The method of claim 10, further comprising:
inserting a foam insert into the cavity of the housing; and
modify impact force values by changing hole density in the foam insert.

16. The method of claim 10, further comprising:
forming one or more openings in the front panel.

17. The method of claim 16, wherein at least one of the openings is shaped to receive a child safety seat.

18. The method of claim 16, further comprising:
attaching one or more buckle assemblies to the housing through the openings.

19. The method of claim 10, wherein:
the front panel and the back panel of the housing are made of foam; and
the foam includes expanded polystyrene and/or expanded polypropylene.
